(19) United States
(12) Patent Application Publication
(10) Pub. No.: US 2019/0014715 A1
(43) Pub. Date: Jan. 17, 2019

(54) CONTROL SYSTEM FOR AN AGRICULTURAL WORK SYSTEM, WORK SYSTEM, USE

(71) Applicant: Robert Bosch GmbH, Stuttgart (DE)

(72) Inventors: Gernot Becker, Stuttgart (DE); Jochen Fehse, Friolzheim (DE); Jochen Fassnacht, Calw (DE); Steffen Rose, Ludwigsburg (DE)

(21) Appl. No.: 16/030,052

(22) Filed: Jul. 9, 2018

(30) Foreign Application Priority Data
Jul. 11, 2017 (DE) 102017211839.3

(51) Int. Cl. A01B 69/04; G05D 1/02; A01D 46/02; G05D 1/00

(52) U.S. Cl. CPC A01B 69/008; G05D 1/0246; G05D 2201/0201; G05D 1/0088; A01D 46/02

(57) ABSTRACT

A control system for an agricultural work system having at least one mobile work machine, which is developed to carry out a predefined work task in an autonomous manner, including an arrangement for the work machine for orientation purposes and/or for a collision avoidance. It is provided that the arrangement includes a multitude of markers which are able to be placed/are placed on objects in an operating range, and at least one device, which is able to be mounted/is mounted on the work machine and designed to detect the markers and to output an item of information to the work machine as a function of a detected marker.

### CROSS REFERENCE

The present application claims the benefit under 35 U.S.C. § 119 of German Patent Application No. DE 102017211839.3 filed on Jul. 11, 2017, which is expressly incorporated herein by reference in its entirety.

### BACKGROUND INFORMATION

The present invention relates to a control system for an agricultural work system, which has at least one mobile work machine developed to carry out a predefined work task in an autonomous manner, including an arrangement for the work machine for orientation purposes and/or for avoiding collisions.

In addition, the present invention relates to a work system and to a use of the control system.

Control systems for agricultural work systems are available in the related art. German Patent Application No. DE 100 27 133 A1 describes an edge-strip mowing device to be installed on a mobile work machine or a work vehicle. The edge-strip mower device has two automatically controllable mower heads in each case, one of the mower heads having a sensing rod, which is developed to scan an environment of the work machine for obstacles in order to avoid a collision.

### SUMMARY

According to an example embodiment of the present invention, an arrangement is provided with a multitude of markers, which are able to be placed/are placed on objects in an operating range; it also has at least one device which is able to be mounted/is mounted on the work machine, designed to detect the markers, and to output an item of information to the work machine as a function of a detected marker. This has the advantage, first of all, that the objects, especially various types of objects, are able to be marked in a particularly simple, precise and cost-effective manner. In this way the operating range may be marked or predefined, especially even before the work task is carried out, so that the task is subsequently able to be carried out in a particularly efficient, and especially in a rapid and thorough manner. In addition, it is advantageous that the objects on which the markers are placed are very easy to detect, in particular because the device carries out the detection. No detection of the objects themselves, e.g., by sensing the objects, is therefore required.

According to one preferred further development of the present invention, the markers are visual markers, in particular reflectors. This offers the advantage that the markers are optically or visually detectable, and thus are able to be detected in an especially uncomplicated manner. Moreover, especially the markers that are developed as visual markers may be purchased very inexpensively. The markers are preferably developed as markers that are coated with a predefinable lacquer or are given a predefinable color. Additionally or alternatively, the visual markers are developed as readable codes, e.g., as QR codes. As an alternative, the markers are developed as markers that emit electromagnetic waves, e.g., in the form of diodes or RFID chips. The markers are preferably developed in such a way that they can be placed on an object using a substance-to-substance connection, such as an adhesive, in a non-positive manner, e.g., with the aid of a magnet, and/or in a form-fitting manner.

The device preferably has at least one camera sensor for detecting the markers. This is advantageous because it allows the marker to be detected in a contact-free manner. This ensures that the markers are not subject to wear by the device for detecting the markers, and thus have a long service life. The camera sensor is preferably a CCD or CMOS sensor, which is developed especially for the detection of light in the visible, infrared, and/or ultraviolet spectral range.

In particular, it is preferably provided that the device has at least one emitter for irradiating the markers. This offers the advantage that the markers are especially easy to detect, in particular regardless of a brightness of the operating range.

The emitter is preferably a light-emitting diode, which is developed especially for emitting light in the visible, infrared and/or ultraviolet spectral range.

According to a preferred further development of the present invention, the markers have the same or different identifying features. This offers the advantage of making objects easy to detect. The detection of the object thus is merely dependent on the identifying feature and therefore independent of the nature of the object itself. Identifying features, for example, are the information of readable codes, especially QR codes, of RFID chips or the spectral information of the predefined lacquers or lacquer colors.

A control unit is preferably provided, which is connected to the device so as to allow for signals to be transmitted, and is connectable/connected to the work machine. This has the advantage that an automatic or autonomous operation of the work machine is able to be realized. More specifically, the information output to the work machine as a function of a detected marker may be utilized for developing an autonomous operation of the work machine. The operation may be a driving operation and/or some other operation for executing a work task. The labor involved for a user of the work machine is reduced, especially on account of an automatic or autonomous execution of a work task by the work machine. The control unit is preferably electrically connected or connectable to the device and to the work machine, in particular a drive unit and/or a steering device of the work machine, in order to control it. The control unit preferably has a data-storage unit in addition. A software and/or an algorithm for evaluating the signals or the identifying features detected by the device is/are preferably stored in the control unit or the data-storage unit. This allows for the detection and evaluation and/or storing of, for instance, position and/or distance data of the markers and/or data pertaining to the operational range.

The driven system, in particular the agricultural work system, which includes at least one work machine developed for the autonomous execution of a predefined work task and a control system for the work machine, is characterized by the development of the control system according to the present invention. This results in the already mentioned advantages. Additional advantages and preferred features in particular result from the description herein.

According to a preferred further development of the present invention, the driven system is developed as a hops-cultivation system. This offers the advantage that a hops cultivation and/or hops harvesting is/are able to be carried out in a particularly efficient manner by the work machine. The markers are preferably disposed on hops plants in this case and/or on hops trellises that are situated between two hops plants in each case. A hops-cultivating region in which the hops plants and/or the hops trellises are found constitutes the operating range in this instance. The hops-cultivating region, in particular the placement of the hops plants and/or the hops trellises, is preferably able to be learned and stored with the aid of the algorithm that is stored in the control unit. As an alternative, the driven system is developed as a fruit- or wine-cultivating system.

The work machine is preferably a motor vehicle on which at least one tool device is positioned, which may be moved and/or operated as a function of the information. This offers the advantage of allowing for a particularly efficient utilization of the work machine in the operating range. The tool device is preferably developed as a mowing tool or a cutting tool, in particular for cutting hops plants. For the automatic actuation of the tool device, the tool device is preferably electrically connected to the control device or to a further control device, or in a manner that allows for the transmission of signals. This not only ensures that the work machine is automatically able to evade the objects marked by markers or to drive around them through an actuation of the drive unit and/or the steering device, but also that the detected objects are able to be processed automatically, in particular cut, by actuating the tool device. This makes it possible to minimize the labor required by a user of the work machine.

The device for detecting the markers is preferably situated in front of the tool device on the motor vehicle in the driving direction of the motor vehicle or the work machine. This ensures that the tool device is able to be actuated in an especially precise manner, in particular when the position of the tool device conforms to the position of the detected marker. Preferably, a clearance between the device and the tool device is known and stored, e.g., in the control unit. A position of the marker is preferably ascertained during a driving operation or a work process, for instance in that the device detects a signal. In addition, the velocity of the work machine is preferably monitored during the driving operation and a traveled distance is ascertained from the velocity. If the ascertained distance corresponds to the distance between the device and the tool device, or in other words, if the position of the tool device corresponds to the position of the marker, then the tool device is preferably moved and/or operated in order to carry out an automatic cutting operation, for instance. Alternatively or additionally, it is provided that the position of the marker and/or the work machine is ascertained with the aid of a satellite-based navigation system, e.g., using a GPS system.

The use of a control system for operating a work system, in particular a hops-cultivation system, which has a plurality of work machines featuring the same and/or a different design, each work machine being developed to carry out a predefined work task in an autonomous manner. This offers the already mentioned advantages. Additional advantages and preferred features in particular result from the description herein.

Below, the present invention is described in greater detail with reference to the figures.

### BRIEF DESCRIPTION OF THE DRAWINGS

FIG. 1 shows a control system for an agricultural work system according to a first exemplary embodiment.

FIG. 2 shows a control system according to a second exemplary embodiment.

### DETAILED DESCRIPTION OF EXAMPLE EMBODIMENTS

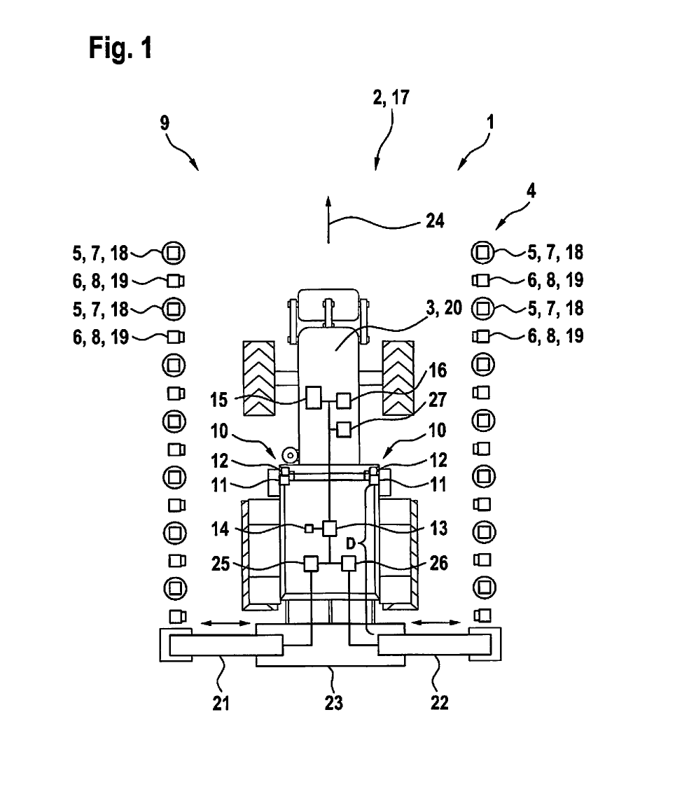

FIG. 1 shows a control system 1 for a work system 2, in particular an agricultural work system, control system 1 having a mobile work machine 3, which is designed to carry out a predefined work task in an autonomous manner. In this context, “agricultural work system” means that work machine 3 is able to carry out work tasks relating to plants, in particular relating to agriculture or to an agricultural cultivation.

Control system 1 includes an arrangement 4 that is provided for work machine 3 for orientation purposes and/or for a collision avoidance. Arrangement 4 includes a multitude of markers 5, 6 for this purpose, which are placed on different objects 7, 8 in an operating range 9 of work machine 3 in this instance. The first markers 5 are disposed on first objects 7 and the other markers 6 are disposed on second objects 8.

In addition, control system 1 has two devices 10, which may be mounted or are mounted on work machine 3, are designed to detect markers 5, 6, and to output an item of information or an electrical signal to work machine 3 as a function of at least one detected marker 5, 6.

In this case, markers 5, 6 are developed as visual markers 5, 6. Visual markers 5, 6 are thus optical markers and therefore particularly easy to detect. For example, markers 5, 6 may be developed as readable codes, in particular QR codes, as RFID chips, or as predefined lacquers.

In the present case, markers 5, 6 have different identifying features in each case, i.e. a first marker 5 has a first identifying feature and second marker 6 has a second identifying feature. The first identifying feature, for example, is a first readable code, in particular a first QR code, or a first RFID code; the second identifying feature is a second readable code, in particular a second QR code, or a second RFID code. This ensures that each one of the first and second objects 7, 8 is able to be individually marked and detected and, in particular, can therefore be distinguished from another marker. Work machine 3 thus preferably has the capability of executing a work task that is predefined or predefinable, especially with regard to detected object 7, 8, as a function of the detected identifying feature or the respective detected marker 5, 6.

In order to detect markers 5, 6, which are developed as visual markers 5, 6 in this instance and have a readable code, device 10 includes at least one camera sensor 11. Camera sensor 11 is preferably developed as a CCD or a CMOS sensor. Device 10 has at least one emitter 12 in order to ensure a particularly reliable illumination and thus a particularly advantageous detectability of markers 5, 6. Emitter 12 is preferably developed as a light-emitting diode, which is designed especially to emit light in the infrared, visible and/or ultraviolet spectral range.

For the detection of markers 5, 6 developed in the form of RFID chips, it is alternatively or additionally provided that device 10 is preferably developed as a receiver system for receiving the electromagnetic waves emitted by the RFID chips.

In this particular case, a control unit 13 is provided, which is connected to device 10 and to work machine 3 in a manner that allows for a transmission of signals. Control unit 13 is preferably a control unit 13 of control system 1, especially of device 10, so that control system 1 is able to be developed as a mobile control system 1, in particular, and be connected to work machine 3 in a manner that allows for the transmission of signals. Alternatively, control unit 13 is a control unit 13 of work machine 3 and is able to be connected to device 10. Control unit 13 is preferably developed to receive and evaluate the signals or information detected by device 10 or camera sensor 11. Control unit 13 in particular includes a data-storage unit 14 for this purpose in which an algorithm and/or a predefinable signal-marker correlation is/are stored, such as in the form of a characteristic curve. In this context, it is provided that control unit 13 or data-storage unit 14 compares the detected signals or information of device 10 with the signal-marker correlation so that it may be accurately determined whether a detected signal is able to be allocated to a respective marker 5, 6.

It is preferably provided that control unit 13 is connected to a drive unit 15 and/or a steering device 16 of work machine 3 in a manner that allows for the transmission of signals for the purpose of its/their actuation. This ensures that work machine 3 is able to be operated in an automatic or autonomous manner. For instance, driving operations and/or steering maneuvers or evasive maneuvers for the purpose of evading an obstacle or an object 9, 10 may be automatically carried out in this manner.

Depending on a detected marker 5, 6, control unit 13 thus is able to output an item of information to work machine 3, in particular to drive unit 15 and/or steering device 16.

In this case, work system 2 or the agricultural work system is developed as a hops-cultivation system 17. Work system 2 or hops-cultivation system 17 includes work machine 3 and control system 1 for work machine 3. First object 7 is a hops plant 18 in this instance, and second object 8 is a hops trellis 19.

Work machine 3 is a motor vehicle 20, in particular a tractor on which—in this instance—two tool devices 21, 22 are disposed, which are able to be moved and operated as a function of the information or the signal from device 10. In this instance, tool devices 21, 22 are developed as cutting tools for cutting hops plants 18. Tool devices 21, 11 are preferably disposed in a housing 23, which may be mounted, or is mounted, on work machine 3 in each case, in particular in a manner that makes them extendable and/or retractable or movable, especially laterally to a driving direction 24. It is preferably provided that a first one of tool devices 21 is laterally movable toward one side and a second one of tool devices 22 is movable toward another side in relation to driving direction 24. This particularly allows for the simultaneous processing or cutting of hops plants 18 disposed along both sides of work machine 3.

In this case, control unit 13 is connected to tool devices 21, 22 for signaling purposes, in particular to a first actuator 25 driving first tool device 21, and to a second actuator 23 driving second tool device 22. For instance, if device 10 detects a marker 5 that marks a hops plant 18, then control unit 13 preferably transmits an actuation signal to at least one of actuators 25, 26 for moving or laterally extending and preferably activating a cutting motion of at least one of tool devices 21, 22. If device 10 detects a marker 6 that marks a hops trellis 19, then control unit 13 preferably transmits an actuation signal to at least one of actuators 25, 26 for moving or laterally retracting and preferably for deactivating a cutting motion of at least one of tool devices 21, 22. A user of work machine 3, who is not shown here, benefits from this insofar as the work task, i.e., the cutting of hops plants 18 in this case, is able to be carried out in a particularly efficient, especially automatic manner by work machine 3 on its own. The user is therefore able to concentrate on a driving task so that an outlay in terms of time and labor is reduced for the user.

In this case, device 10 for detecting markers 5, 6 is situated in front of tool device 21, 22 on motor vehicle 20 or work machine 3 in driving direction 24 of motor vehicle 20 or work machine 3. A distance D between device 10 and tool device 21, 22 is preferably known and preferably stored in control unit 13. It is provided that device 10 or camera sensor 11 initially detects a signal from marker 5, 6 and transmits the signal to control unit 13 so that control unit 13 is able to determine the position of marker 5, 6 or of object 7, 8. During a driving operation, the velocity of work machine 3 is preferably monitored in addition and a traveled distance is ascertained from the velocity. If the ascertained traveled distance corresponds to distance D between device 1 and tool device 21, 22, then tool device 21, 22 is preferably actuated, for instance in order to carry out an automatic cutting operation.

Alternatively or additionally, it is provided that marker 5, 6 is detected by device 10 and that the detected signal of device 10 is stored as positional information or as a coordinate in control unit 13 or data-storage unit 14. Control unit 13 or data-storage unit 14 preferably has a communications link to a satellite-based navigation system, e.g., a GPS system. This ensures that the stored coordinate is able to be compared to a GPS coordinate or to GPS information in order to thereby determine whether the position of tool device 21, 22 coincides with the position of marker 5, 6. If the ascertained position corresponds to the detected position, then tool device 21, 22 is preferably actuated in order to perform an automated cutting operation, for example.

In an effort to avoid damage to a hops plant 18, for instance because its marker 5 is missing or has become unidentifiable, it is preferably provided to predefine and store a distance between two hops plants 18 or a position of a hops plant 18 in control unit 13 or data-processing unit 14. For example, if camera sensor 11 fails to detect a marker 5, and thus a hops plant 18, in a position where a hops plant 18 is expected based on the stored position, for example, then it is provided that tool device 21, 22 is automatically retracted and/or deactivated at least for this position. Since camera sensor 11 is disposed in front of tool device 21, 22 on work machine 3 in driving direction 24, this predefinable and stored distance D may be utilized as a tolerance distance within which a next or following marker 5, 6 or object 7, 8 must be detected in driving direction 24.

Additionally or alternatively, it is provided that if no marker 5, 6 is detected at the stored, expected position, a warning signal is output, e.g., acoustically or optically, to the user of work machine 3, preferably with the aid of a signaling device 27 of work machine 3 which is preferably able to be actuated by control unit 13. It is preferably provided that control unit 13, for example, monitors signaling device 27 for a reaction of the user to the warning signal. If the user confirms after the output of the warning signal that no marker 5, 6 or object 7, 8 was actually found, then tool device 21, 22 remains in its cutting position, in particular. If the confirmation fails to occur, then it is preferably provided to automatically retract tool device 21, 22 or pull it back into housing 23.

In order to predefine and/or store a distance between two hops plants 18 or a position of a hops plant 18, it is provided that during a driving operation of work machine 3 through hops-cultivation region 17, a pattern of the recurring events, especially the detected signals, and thus of hops-cultivation region 17, be produced or taught by the algorithm of control unit 13 on the basis of the detected signals of device 10. In this particular instance, the pattern is a straight line on which markers 5, 6 and/or objects 7, 8 are disposed at regular intervals. Based on the detected signals, this results in a corresponding development of the pattern. A distance between hops plants 18 is able to be determined from the traveled distance and from the position of hops plants 18 using the detected signals of device 10 or camera sensor 11. A combination or completion of the pattern may additionally be accomplished with the aid of further quantities such as a steering angle. This makes it possible to use the corresponding pattern, which is learned in this case, for the hops-cultivation region 17 over and over again. Because of the learned pattern, a fault-tolerant control system 1 may be realized with the aid of the learned pattern, which is able to reliably assist the user in the work even if at least one marker 5, 6 is missing and which avoids collisions of work machine 3.

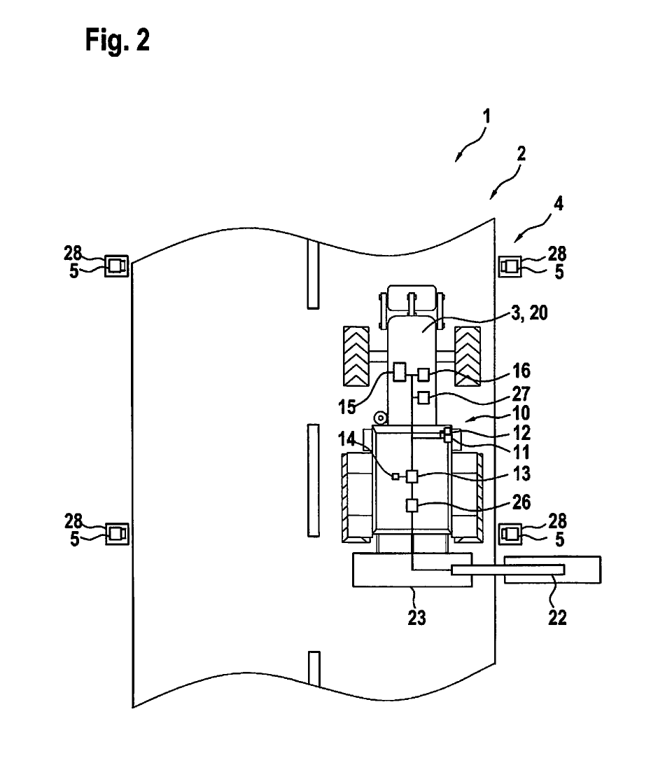

FIG. 2 shows work system 2 from FIG. 1 as well as control system 1. Features that are in FIG. 1 have been provided with the same reference numerals in FIG. 2. In contrast to FIG. 1, work system 2 now is a road-edge mowing system, and markers 5 having the same identifying features have been placed on objects 28, which are developed as road-edge guideposts. In this particular instance, only one tool device 22 is provided, which is extended in the direction of the road edge. Moreover, tool device 22 is now developed as a mowing tool.

Due to the uniform marking of objects 7, 8, 28 with the aid of markers 5, 6, control system 1 is able to be utilized in a universal manner for different intended uses without any further outlay, as a result of a low number of adjustable parameters, in particular only a signal evaluation of the signals detected by device 10. A specific application for a particular intended use thus is no longer needed. The required work in connection with the object detection may therefore be reduced to a uniform feature or an identifying feature, which means that the development expense for a work machine 3 or a control system 1 is able to be considerably reduced. As a result, a universally employable control system 1 or work system 2, which may even be used for niche applications, is able to be developed and/or offered. In addition, an object 7, 8, 28 is detected in a contact-free manner so that a working speed is high and the detection takes place in a maintenance-free manner. The actuation of tool device 21, 22 furthermore ensures that no driving around hops trellis 19 is necessary, especially for cutting hops plant 18. This simplifies and accelerates the execution of the work task.

Moreover, a use of the control system for operating the work system is provided, in particular hops-harvesting system 17, which includes a plurality of work machines 3 having the same and/or a different design, the respective work machine 3 being developed to carry out a predefined work task in an autonomous manner.

What is claimed is:

1. A control system for an agricultural work system having at least one mobile work machine, which is designed to carry out a predefined work task in an autonomous manner, the control system comprising:
an arrangement provided for the work machine for at least one of orientation purposes, and a collision avoidance, wherein the arrangement includes a multitude of markers, which are able to be placed on objects in an operating range of the work machine; and
at least one device mountable on the work machine and designed to detect the markers and to output an item of information to the work machine as a function of detected ones of the markers.

2. The control system as recited in claim 1, wherein the markers are visual markers, the visual markers being reflectors.

3. The control system as recited in claim 1, wherein the device has at least one camera sensor for detecting the markers.

4. The control system as recited in claim 1, wherein the device has at least one emitter for illuminating the markers.

5. The control system as recited in claim 1, wherein the markers have identifying features.

6. The control system as recited in claim 5, wherein the identifying features are at least one of: (i) QR codes, (ii) RFID chips, or (iii) predefined lacquers.

7. The control system as recited in claim 1, further comprising:
a control unit which is connected to the device in a manner that allows for the transmission of signals and is able to be connected to the work machine.

8. An agricultural work system, comprising:
at least one work machine developed to carry out a predefined work task in an autonomous manner;
a control system for the work machine, the control system including an arrangement provided for the work machine for at least one of orientation purposes, and a collision avoidance, wherein the arrangement includes a multitude of markers, which are able to be placed on objects in an operating range of the work machine, and at least one device mounted on the work machine and designed to detect the markers and to output an item of information to the work machine as a function of detected ones of the markers.

9. The work system as recited in claim 8, wherein the work system is a hops-cultivation system.

10. The work system as recited in claim 8, wherein the work machine is a motor vehicle on which at least one tool device is mounted, which is able to be, as a function of the information, at least one of moved and operated.

11. The work system as recited in claim 10, wherein the device for detecting the markers is situated in front of the tool device on the motor vehicle in a driving direction of the motor vehicle.

12. A hops-harvesting system, comprising:
a plurality of work machines, each of the work machines developed to carry out a predefined work task in an autonomous manner;
a control system for the work machines, the control system including an arrangement provided for the work machines for at least one of orientation purposes, and a collision avoidance, wherein the arrangement includes a multitude of markers, which are able to be placed on objects in an operating range of the work machines;
wherein each respective one of the work machines includes at least one device mounted on the respective work machine and designed to detect the markers and to output an item of information to the respective work machine as a function of detected ones of the markers.
